(19) United States
(12) Patent Application Publication
(10) Pub. No.: US 2025/0214467 A1
(43) Pub. Date: Jul. 3, 2025

(54) POWER TRANSFORMER ASSEMBLY

(71) Applicant: BRUSA ELEKTRONIK AG, Buchs (CH)

(72) Inventors: Veit PFÄTTISCH, Buchs (CH); Konrad ZEGULA, München (DE); Nikola IVANCIC, Buchs (CH)

(21) Appl. No.: 18/850,162

(22) PCT Filed: Mar. 24, 2023
(86) PCT No.: PCT/EP2023/057629

§ 371 Date: Sep. 24, 2024

(30) Foreign Application Priority Data
Mar. 26, 2022 (CH) CH000338/2022

(51) Int. Cl. B60L 53/302; B60L 53/12; H01F 27/10; H01F 27/22

(52) U.S. Cl. CPC B60L 53/302; B60L 53/12; H01F 27/22; H01F 27/10

(57) ABSTRACT

A wireless charger for charging a high-voltage (HV) battery of a vehicle, comprising a coil configured for wirelessly receiving an oscillating magnetic field from an external transmitter, thereby creating an alternating current (AC), a ferrite arranged adjacent to the coil, cooling channels arranged adjacent to at least one of the ferrite and the coil, the cooling channels configured for providing a flow of coolant, electric components configured for charging the HV battery based on the AC, a metal cover separating the coil and the ferrite from the electric components, at least one of the electric components being arranged adjacent to the metal cover, wherein the wireless charger further comprises an electrically non-conductive part configured for forming the cooling channels at least in part and separating the coil and the ferrite from the metal cover.

### CROSS-REFERENCE TO RELATED APPLICATIONS

The present application is the U.S. National Phase of PCT/EP2023/057629, filed on 24 Mar. 2023, which claims priority to Swiss Patent Application No. CH000338/2022, filed on 26 Mar. 2022, the entire contents of which are incorporated herein by reference.

### FIELD OF THE INVENTION

The present invention relates to a power transformer assembly for transforming electromagnetic power of an oscillating electromagnetic field into electric power of an electric current or available electric current for charging an electric storage device or energizing an electric load. The power transformer assembly comprises a magnetic assembly for receiving the oscillating electromagnetic field and transforming it into an electric alternating current, and an electronic assembly for receiving the electric alternating current and transforming it into the electric current or available electric current. The power transformer assembly further comprises heat dissipation means for dissipating heat generated by the electronic assembly during their respective power transforming operation.

The power transformer assembly, also referred to as a wireless charger module, may be used for charging a high-voltage (HV) battery of a vehicle. Such a module, sometimes also referred to as car-pad module (CPM), can receive an oscillating magnetic field from an external transmitter, which is sometimes referred to as ground-pad module (GPM), and transform the oscillating electromagnetic, predominantly magnetic field, into an alternating current which is converted (typically rectified) into an electric current (typically a direct current) used for charging the HV battery.

### BACKGROUND OF THE INVENTION

Batteries of electric vehicles can be charged using alternating current (AC) or direct current (DC) energy transfer. DC energy transfer is typically provided using high-power converters which are placed at dedicated charging points. While DC charging is typically faster than AC charging, it is not convenient for the end user as DC charging points are typically placed in remote areas and not installed in houses or residential areas, as the installation of a DC charging point is expensive and the preexisting network capacity in those areas is usually vulnerable.

AC charging on the other hand is very important for residential areas and (semi) public urban areas. Typical AC chargers are capable of providing a charging power of up to 22 KW. AC charging systems can be divided into wired charging systems and wireless charging systems, wherein wireless charging systems are mainly embodied as inductive charging systems (ICSs). Wired AC chargers are typically integrated in electric vehicles, and are also referred to as on-board chargers. An ICS typically comprises two separate modules which are often referred to as ground-pad module (GPM) and car-pad module (CPM).

The GPM is installed outside the electric vehicle while the CPM is installed inside the electric vehicle, usually on the bottom side of the vehicle. Electromagnetic interaction between the GPM and the CPM enables energy transfer from the GPM to the CPM, and the CPM is in turn used for charging a battery of the electric vehicle. Wireless charging systems are often more convenient for a user as typically no manual intervention is required for starting the charging process of the battery other than parking the vehicle above the GPM. Wired charging systems on the other hand require the user to connect the electric vehicle to a utility grid via a cable.

The term “GPM” as used herein is to be understood as an equivalent to the term “wireless charging supplier” or simply “supplier” as used herein. The term “CPM” as used herein is to be understood as an equivalent to the term “wireless charger” or simply “charger” as used herein. Also, in the present text, the terms “power transformer assembly” and “wireless charger” or “wireless charger module” are used interchangeably.

When it comes to cooling, it is important to understand that a CPM has two regions of heat generation: (a) the electronic assembly (power electronics) generating a lot of heat, but relatively concentrated at specific locations (high density), and (b) the magnetic assembly (coil and ferrite) generating less and relatively well distributed heat (low density). Prior art cooling systems for such CPMs are not well tailored to these circumstances and are relatively difficult to manufacture and thus expensive.

### OBJECT OF THE INVENTION

Therefore, it is an object of the invention to provide a power transformer assembly which meets the overall cooling requirements and, in particular, the electronic assembly cooling requirements and which can be manufactured easily and at relatively low cost.

### SUMMARY OF THE INVENTION

This object is achieved by a power transformer assembly for transforming electromagnetic power of an oscillating electromagnetic field into electric power of an electric current for charging an electric storage device or energizing an electric load, the power transformer assembly comprising:
a magnetic assembly for receiving the oscillating electromagnetic field and transforming it into an electric alternating current;
an electronic assembly for receiving the electric alternating current and transforming it into the electric current, wherein the power transformer assembly comprises heat dissipation means for dissipating heat generated by the magnetic assembly and by the electronic assembly during their respective power transforming operation, characterized in that:
a) the heat dissipation means is arranged between the magnetic assembly and the electronic assembly and in thermal contact with the magnetic assembly and the electronic assembly;
b) the heat dissipation means comprises:
a first part in thermal contact with the magnetic assembly, and
a second part in thermal contact with the electronic assembly;
c) the first part comprises a first material and/or has a first structure adapted to dissipate heat flow from the magnetic assembly; and
d) the second part comprises a second material different from the first material and/or has a second structure different from the first structure adapted to dissipate heat flow from the electronic assembly.

As a result, the first part in thermal contact with the magnetic assembly and comprising a first material and/or first structure adapted to dissipate heat flow from the magnetic assembly provides a first portion of overall heat dissipation from the power transformer assembly. Similarly, the second part in thermal contact with the electronic assembly and comprising a second material different from the first material and/or having a second structure different from the first structure adapted to dissipate heat flow from the electronic assembly provides a second portion of overall heat dissipation from the power transformer assembly.

In other words, with the magnetic assembly being a first type of heat source and the electronic assembly being a second type of heat source in the power transformer assembly, the invention enables heat source specific heat dissipation by providing the first part as a first type of heat sink and the second part as a second type of heat sink. By allowing the material and/or structure of the first part (first type of heat sink) and of the second part (second type of heat sink) to be different from each other, each of the first and second parts needs to meet the heat dissipation requirements of the magnetic assembly (first type of heat source) and the electronic assembly (second type of heat source), respectively. Therefore, the first part can be provided with a first material and first structure primarily meeting the heat dissipation requirements of the magnetic assembly only, and the second part can be provided with a second material and second structure primarily meeting the heat dissipation requirements of the electronic assembly only. Thus, the specific heat dissipation requirements for each of the first and second parts can be minimalistic which allows significant savings to be achieved. For instance, savings can be achieved by selecting a material with low thermal conductivity, and the low thermal conductivity may be compensated by providing this material with a special structure which lends itself to improving heat flow.

The invention further facilitates more design flexibility for the power transformer and a reduction of involved parts.

Preferably, the first part comprises a first material having a first thermal conductivity and the second part comprises a second material having a second thermal conductivity, the second thermal conductivity being greater than the first thermal conductivity.

Preferably, a thermal conductivity of the second material is greater than 100 W/(m·K). This guarantees sufficient heat flow from the electronic assembly as a heat source with concentrated hot spots and relatively high temperatures.

Preferably, the first material and/or the second material is a metal, a metal alloy, a polymer, a polymer blend or a composite material.

Preferably, the first material is a polymer or a polymer blend.

Preferably, the second material is a metal, a metal alloy or a composite material.

In a preferred embodiment, the first part comprises a portion defining ducts for a heat transfer fluid (coolant). This allows the first part to be arranged in fluid connection with a coolant circuit, with the ducts of the first part preferably being a portion of the coolant circuit.

Preferably, the first part with the duct-defining portion is made by forming (shaping) a material in a mold. This allows the cost of manufacturing to be reduced.

The first part with the duct-defining portion may be made by molding (casting, injecting) a moldable material in the mold.

The first part with the duct-defining portion may be made by sintering a sinterable material within the mold.

The first part with the duct-defining portion may be made by cross-linking a cross-linkable material within the mold.

Preferably, the first part with the duct-defining portion is made additively in a layer-by-layer fashion. This allows complicated geometries for the first part to be manufactured which lend themselves to efficient heat transfer from the magnetic assembly (coil, ferrite), as a more evenly distributed heat source, to the first part as heat sink with a heat transfer fluid (coolant) flowing through the ducts.

Preferably, the first part comprises a polymer. This allows the first part with its duct geometries to be manufactured by low-cost molding.

The first part may comprise a polymer matrix having particles dispersed therein, said the particles being selected from the group comprising metal particles and graphite particles. These particles increase the polymer's electric conductivity.

Preferably, the second part comprises a solid metal material. This guarantees sufficient heat flow from the electronic assembly as a heat source with concentrated hot spots and relatively high temperatures. In addition, it provides extra mechanical strength to the overall dissipation means.

Preferably, the second part comprises a porous metal material. This allows the amount of required metal material to be reduced without any significant reduction in thermal conductivity and mechanical strength of the second part. Thus, weight and material cost can be reduced with respect to the solid metal material.

In a preferred embodiment, the second part comprises a metal layer. This metal layer contributes to homogenizing the local temperature peaks/hot spots of the electronic assembly by heat flow in the lateral direction along the metal layer.

Preferably, the magnetic assembly comprises a coil.

Preferably, the magnetic assembly comprises a material adjacent to the coil, the material having a permeability greater than or equal to 1.

Preferably, the material adjacent to the coil is a ferrite.

Preferably, the electronic assembly comprises a power electronics part.

Preferably, the heat dissipation means comprises a third part arranged between the first part and the magnetic assembly. As mentioned before, the first part can be provided with a first material and first structure primarily meeting the heat dissipation requirements of the magnetic assembly only, and the second part can be provided with a second material and second structure primarily meeting the heat dissipation requirements of the electronic assembly only. With the third part, the overall heat dissipation properties provided by the first and second parts can be further modified. In addition, each of the three parts can be provided with its own material and geometry.

Therefore, the overall heat dissipation means of the power transformer assembly or wireless charger according to the invention can be assembled in a modular manner with two or three heat dissipation parts to obtain specific heat dissipation and mechanical properties of the overall heat dissipation means.

Preferably, the third part comprises a solid metal material. This guarantees sufficient heat flow from the magnetic assembly. Again, it provides extra mechanical strength to the overall dissipation means.

Preferably, the third part comprises a porous metal material. Again, this allows the amount of required metal material to be reduced without any significant reduction in thermal conductivity and mechanical strength of the third part. Thus, weight and material cost can be reduced with respect to the solid metal material.

Preferably, the third part comprises a metal layer. Again, this metal layer contributes to homogenizing any local temperature non-uniformities of the magnetic assembly by heat flow in the lateral direction along the metal layer.

Preferably, a three-part sandwich arrangement composed of the first part, the second part and the third part is arranged between the magnetic assembly and the electronic assembly and in thermal contact with each of them. The three-part sandwich arrangement composed of the first, second and third parts defined above lends itself to improving the mechanical strength of this sandwich-type overall heat dissipation means. Preferably, this sandwich structure is arranged between the magnetic assembly (first heat source) and the electronic assembly (second heat source) and in thermal contact with each of them. Preferably, the second part and the third part have a higher mechanical strength than the first part in between the two of them. This provides the overall heat dissipation means with high bending stiffness. Preferably, the second and third parts are made from a solid or porous metal layer while the first part in between may be made from a polymer. The first part may be a web structure, preferably a perforated honeycomb structure, permitting coolant flow while providing high bending stiffness with little weight.

Preferably, the ducts for the heat transfer fluid defined by the material of the first part comprise a plurality of flow obstacles extending across the ducts.

At least some of the flow obstacles may be formed integrally with the first part.

At least some of the flow obstacles may be formed integrally with the second part.

At least some of the flow obstacles may be formed integrally with the third part.

Preferably, the first part comprises functional portions formed integrally with the duct-defining material of the first part.

These functional portions may comprise at least one of a heat transfer fluid (coolant) inlet, a heat transfer fluid (coolant) outlet, a snorkel (breathing element) and interface formations.

For instance, the invention relates to a wireless charger for charging a high-voltage (HV) battery of a vehicle, comprising a coil configured for wirelessly receiving an oscillating magnetic field from an external transmitter, thereby creating an alternating current, a ferrite arranged adjacent to the coil, cooling channels arranged adjacent to at least one of the ferrite and the coil, the cooling channels configured for providing a flow of coolant, electric components configured for charging the HV battery based on the AC, a metal cover separating the coil and the ferrite from the electric components, at least one of the electric components being arranged adjacent to the metal cover, wherein the wireless charger further comprises an electrically non-conductive part configured for forming the cooling channels at least in part and separating the coil and the ferrite from the metal cover.

In some embodiments, the cooling channels are formed at least in part by recesses machined or formed into the electrically non-conductive part.

In some embodiments, the cooling channels are formed by the metal cover closing the recesses by abutting the electrically non-conductive part.

In some embodiments, the wireless charger further comprises a plate, wherein the cooling channels are formed by the plate closing the recesses by abutting the electrically non-conductive part, the plate separating the electrically non-conductive part from the metal cover.

In some embodiments, the cooling channels are incorporated into the electrically non-conductive part.

In some embodiments, the metal cover is at least a part of a housing of the HV battery.

In some embodiments, the metal cover comprises structure for enlarging the heat sink, the structure dipping into the cooling channels.

In some embodiments, the wireless charger further comprises a coolant inlet and a coolant outlet, both coolant inlet and coolant outlet being machined or formed into the electrically non-conductive part.

In some embodiments, the metal cover is glued onto the non-conductive part.

In some embodiments, the metal cover is flat at least in an area adjacent to the non-conductive part.

In some embodiments, the non-conductive part is made of plastic.

In some embodiments, coil and ferrite are combined in one potting.

In some embodiments, the wireless charger further comprises a coil cover made of plastic, the potting embedded in the coil cover, the coil cover configured to be joined with the non-conductive part.

In some embodiments, the wireless charger further comprises sealing lips bordering or encompassing the cooling channels.

In some embodiments, the metal cover is made of aluminium and configured for shielding the vehicle from the oscillating magnetic field.

### BRIEF DESCRIPTION OF THE DRAWINGS

By way of example only, preferred embodiments of the invention will be described more fully hereinafter with reference to the accompanying figures, wherein:

FIG. 1 shows in a top view a garage, where a vehicle is parking over a wireless charging supplier that is external to the vehicle and has a transmitter for transmitting an oscillating magnetic field;

FIG. 2 shows a zoom into FIG. 1 and shows the wireless charging supplier and a wireless charger for charging a high-voltage (HV) battery of the vehicle;

FIG. 3 shows the charger from FIG. 2 in a close-up 3D view;

FIG. 4 shows a cross-section of a charger according to the prior art;

FIG. 5 shows an example embodiment (first embodiment) of the inventive charger;

FIG. 6 schematically shows a further example embodiment (second embodiment) with the metal cover being “donated” by the housing of the HV battery;

FIG. 7 shows an example embodiment (third embodiment) of a wireless charger comprising a coolant inlet and a coolant outlet both machined or formed into the electrically non-conductive part;

FIGS. 8A and 8B schematically show another embodiment (fourth embodiment) as a cross-section and a perspective view, respectively; and

FIGS. 9A and 9B schematically show a further embodiment (fifth embodiment) as a cross-section and a perspective view, respectively.

### DETAILED DESCRIPTION OF THE DRAWINGS

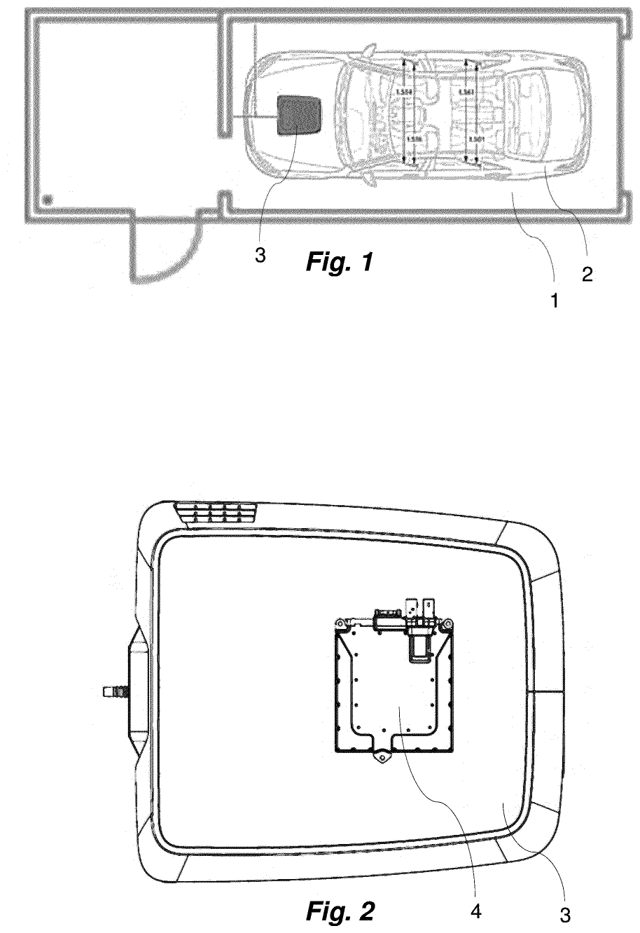

FIG. 1 shows in a top view a garage 1, where a vehicle 2 is parking over a wireless charging supplier 3 that is external to the vehicle 2 and has a transmitter for transmitting an oscillating magnetic field. The supplier 3 can be seen as the vehicle 2 is depicted as being transparent. Such a charging solution is very convenient and saves the driver the plugging and unplugging of a charging cable.

FIG. 2 is a zoom into FIG. 1 and shows the wireless charging supplier 3 and furthermore, “floating” over the supplier 3, a wireless charger 4 for charging a high-voltage (HV) battery of the vehicle 2. The charger 4 is built into the vehicle, which means that, in this view, the rest of the vehicle is hidden.

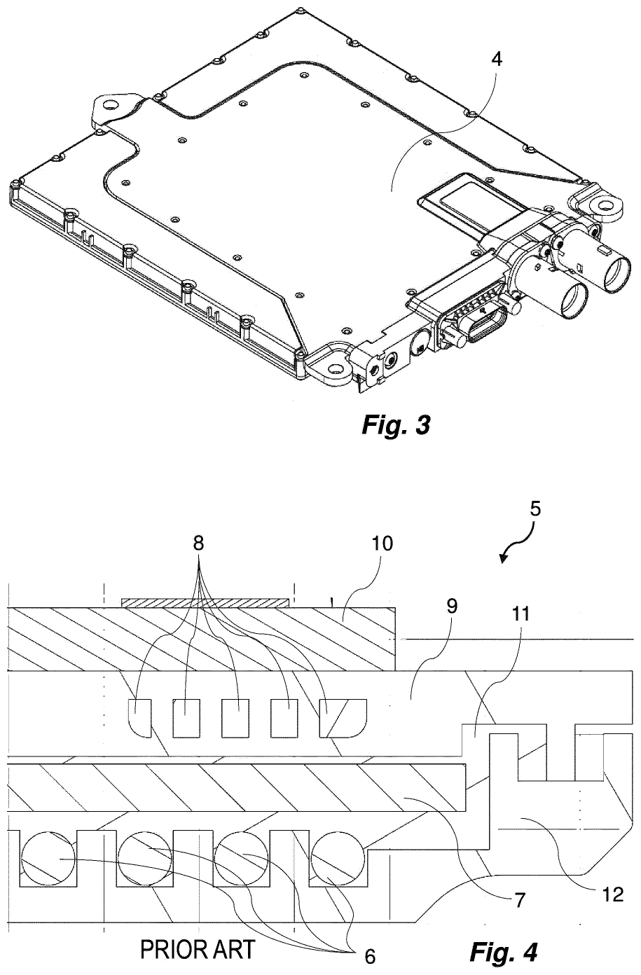

FIG. 3 shows the charger 4 in a close-up 3D view.

FIG. 4 shows a cross-section of a charger 5 according to the prior art. The charger 5 has a coil 6 configured for wirelessly receiving the oscillating magnetic field from the external transmitter included in the wireless charging supplier 3. The oscillating fields induce an alternating current (AC) in the coil. A ferrite 7 is arranged adjacent to the coil 6. Cooling channels 8 are arranged adjacent to the ferrite 7 and configured for providing a flow of coolant. The flowing coolant cools down the metal cover 9 in which the cooling channels are incorporated. Electric components 10 configured for charging the HV battery based on the AC are arranged adjacent to the metal cover for heat dissipation. The metal cover 9 separates the coil 6 and the ferrite 7 from the electric components 10. The coil 6 and ferrite 7 are embedded in a potting 11 that is protected by a coil cover 12. Potting 11 and coil cover 12 are usually mode of plastic.

A disadvantage of the setup described with FIG. 4 is the occurrence of relatively high Eddy current losses as the coil/ferrite 6/7 arrangement is quite close to the metal cover 9 and not isolated against it. Also, more specifically, the setup shown in FIG. 4 causes quite complex deformations due to heat expansion, as the metal cover 9 is hooked into the magnetic assembly 11/12, which has, as a plastic part, a rather different thermal expansion coefficient than the metal cover 9. These relative movements may cause material fatigue in the long run. Furthermore, the complex geometry of the metal cover 9 is difficult and expensive to accomplish.

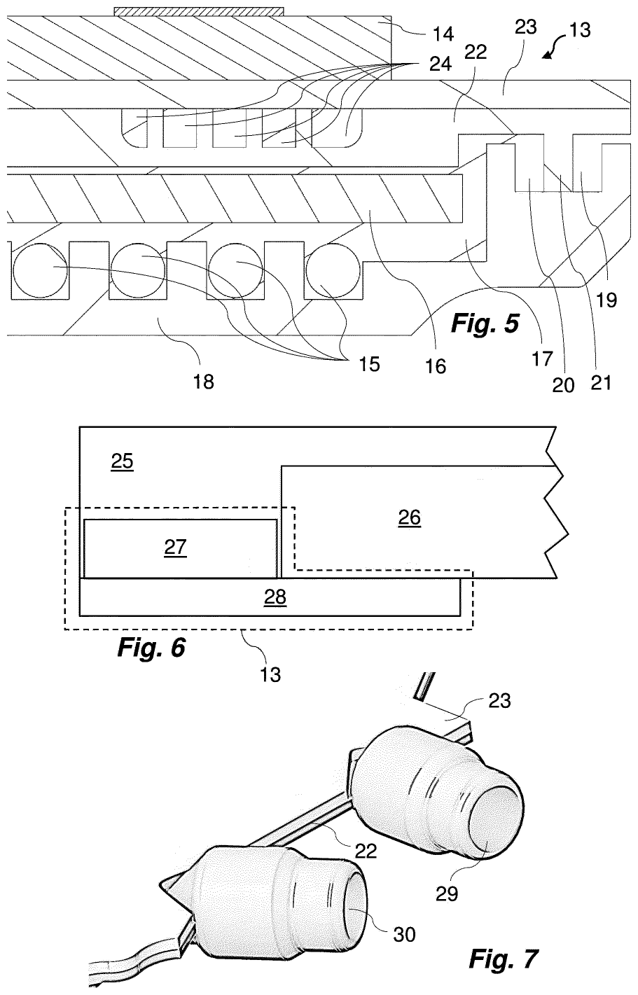

Despite the differences as will be explained with FIG. 5, the wireless charger in accordance with the invention has the components as explained above with FIG. 4. The one or more electric components 10 (or 14 in FIG. 5) involved may comprise at least one of a tuner, a rectifier, a DC/DC converter, and a EMC filter. Furthermore, the wireless charger 13 may comprise a wireless data receiver (not shown) that allows a control of the charging process, in particular, control of the DC/DC converter. Another optional component is a sensor (not shown) that may be used to determine a positioning of the charger 13 relative to an electric power supplier (as shown in FIGS. 1 and 2 with numeral 3) above which the vehicle has parked.

FIG. 5 shows an example embodiment of the inventive charger. The coil 15 and the ferrite 16 are embedded in the potting 17, which is embedded in the coil cover 18. The coil cover 18 has a recess 19 for receiving a lug 20 of the potting 17. The recess 19 is further configured to receive a lug 21 belonging to the electrically non-conductive part 22. The electrically non-conductive part 22 may be manufactured, e.g., from plastic, in particular, by injection molding. Advantages of this part 22 include: (a) it is directly in contact with the potting 20 which has a similar heat expansion coefficient, thus causing little to no relative movement between the two components due to thermal expansion; (b) it is lighter than parts known from prior art chargers; (c) it is easier and cheaper to manufacture; (d) it shields the metal cover 23 and the power electronic component(s) 14 from the oscillating magnetic fields arriving at the coil 15, thereby reducing Eddy losses during charging; (e) it allows the metal cover 23 to have a flat surface where it abuts the electrically non-conductive part 22 so that during thermal expansions, a relative movement does not cause excessive tensions.

The metal cover 23 may be glued onto the electrically non-conductive part 22, wherein this adhesive bond can compensate the relative movement when the system is heating up or cooling down. The cooling channels 24 are formed by recesses in the electrically non-conductive part 22 that are closed by the abutting metal cover 23. The electrically non-conductive part 22, particularly made of plastic, has a relatively low thermal conductivity. However, since most of the heat (or at least, the highest heat density) occurs on side of the power electronics 14 and the heat generation in the magnetics area (15-18) is well distributed and not so critical, the low thermal conductivity of the electrically non-conductive part 22 is no drawback. The direct contact between the coolant flowing through the cooling channels and the metal cover 23 ensures that the heat is removed from the electrical part(s) 14 efficiently. Optional geometry machined into the metal cover 23, e.g., pins or fins immersing in the recesses, may further improve heat dissipation.

The advantage of having two separate parts, of which one is thermally highly conductive and the other is not, symbiotically forming the cooling channels further is that the metal cover can also be used for further purposes. In other words, the component used as the metal cover can be “lent” from a different part of the vehicle, such as the vehicle body or the housing of the HV battery.

FIG. 6 schematically shows the latter example. In this embodiment, the battery housing 25 houses the HV battery 26 and power electronics 27 that are necessary to charge the HV battery 26 based on the AC created in the coil by wirelessly receiving an oscillating magnetic field from the transmitter of an external supplier. These power electronics 27 correspond to the electrical component(s) 14 to be cooled and as shown in FIG. 5. The area where the magnetics 28 are mounted onto the battery housing 25 corresponds to the metal cover 23 as shown in FIG. 5. The magnetics 28 correspond to the coil 15, the ferrite 16, the potting 17, and the coil cover 18.

One advantage of the configuration displayed in FIG. 6 is a reduced weight because at least one part can be omitted. A further benefit is that the wireless charger (or at least parts thereof) can be retrofitted onto vehicles that may not yet have such feature (given that the electronic components 27 are pre-installed). Also, the guidance of the coolant through a plastic part 22 may have the benefit that it can melt in case of a fire and thereby release the coolant to help extinguish the fire.

In a further embodiment, as shown in FIG. 7, the wireless charger comprises a coolant inlet 29 and a coolant outlet 30 both being machined or formed into the electrically non-conductive part 22. If the injection molding technique is used for the production of the non-conductive part 22, the formation of the coolant inlet 29 and the coolant outlet 30 is very easy and cheap to achieve. The coolant pump (not shown) can be connected to the coolant inlet 29 and coolant outlet 30 and, e.g., mounted next to the charger 13.

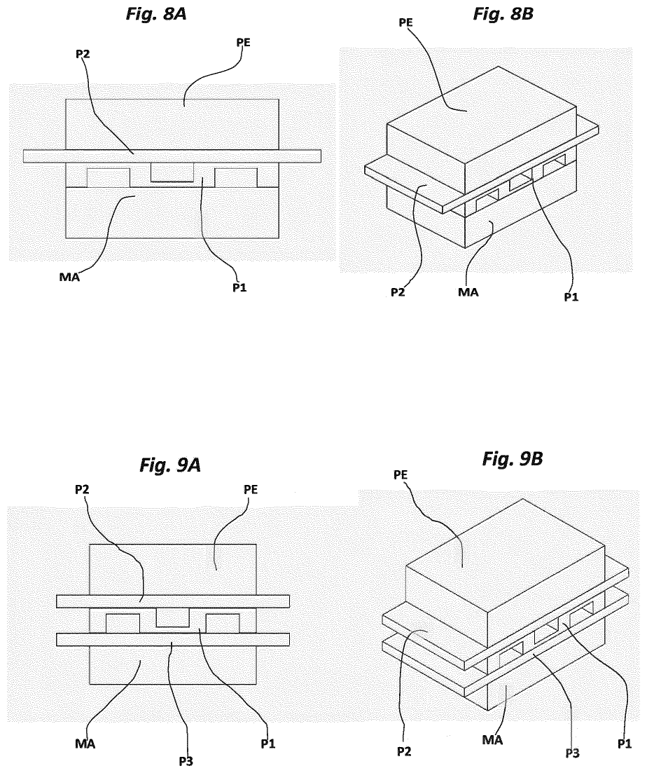

FIGS. 8A and 8B schematically show another embodiment as a cross-section and as a perspective view, respectively.

The power transformer assembly 13 is configured for transforming electromagnetic power of an oscillating electromagnetic field into electric power of an electric current for charging an electric storage device or energizing an electric load. The power transformer assembly comprises a magnetic assembly MA for receiving the oscillating electromagnetic field and transforming it into an electric alternating current. The power transformer assembly also comprises an electronic assembly PE for receiving the electric alternating current AC and transforming it into the electric current for charging an electric storage device or energizing an electric load. In addition, the power transformer assembly comprises heat dissipation means P1, P2 for dissipating heat generated by the magnetic assembly MA and by the electronic assembly PE during their respective power transforming operation.

The heat dissipation means P1, P2 is arranged between the magnetic assembly MA and the electronic assembly PE and in thermal contact with the magnetic assembly MA and the electronic assembly PE. The heat dissipation means P1, P2 comprises a first part P1 in thermal contact with the magnetic assembly MA and a second part P2 in thermal contact with the electronic assembly PE.

The first part P1 comprises a first material and/or has a first structure adapted to dissipate heat flow from the magnetic assembly MA. The second part P2 comprises a second material different from the first material and/or has a second structure different from the first structure adapted to dissipate heat flow from the electronic assembly PE.

Preferably, the first part P1 is made from a polymer material which is easily manufactured by molding, for instance, by injection molding.

Preferably, the second part P2 is made from a metal material.

FIGS. 9A and 9B schematically show a further embodiment (fifth embodiment) as a cross-section and as a perspective view, respectively.

The power transformer assembly 13 shown in FIGS. 9A and 9B differs from the power transformer assembly shown in FIGS. 8A and 8B in that the heat dissipation means P1, P2, P3 comprises a third part P3 arranged between the first part P1 and the magnetic assembly MA.

Preferably, the first part P1 is made from a polymer material which is easily manufactured by molding, for instance, by injection molding.

Preferably, the second part P2 is made from a metal material.

Preferably, the third part P3 is made from a metal material.

An example power transformer assembly 13 or wireless charger 4,13 for charging a high-voltage (HV) battery 26 of a vehicle 2, comprises:
a coil 15 configured for wirelessly receiving an oscillating magnetic field from an external transmitter, thereby creating an alternating current (AC);
a ferrite 16 arranged adjacent to the coil;
cooling channels 24 arranged adjacent to at least one of the ferrite and the coil, the cooling channels being configured for providing a flow of coolant;
electric and/or electronic components 14 configured for charging the HV battery based on the AC;
a metal cover 23 separating the coil and the ferrite from the electric components;
at least one of the electric components being arranged adjacent to the metal cover; and
an electrically non-conductive part 22 configured for forming the cooling channels at least in part and separating the coil and the ferrite from the metal cover.

The cooling channels 24 may be formed at least in part by recesses machined or formed into the electrically non-conductive part 22.

The cooling channels 24 may be formed by the metal cover 23 closing the recesses by abutting the electrically non-conductive part 22.

The cooling channels may be formed by a plate closing the recesses by abutting the electrically non-conductive part, the plate separating the electrically non-conductive part from the metal cover.

The cooling channels may be incorporated into the electrically non-conductive part.

The metal cover 23 may be at least a part of a housing 25 of the HV battery 26.

The metal cover may comprise a structure for enlarging the heat sink, the structure dipping into the cooling channels.

A coolant inlet 29 and a coolant outlet 30 may be provided, both coolant inlet and coolant outlet being machined or formed into the electrically nonconductive part 22.

The metal cover 23 may be glued onto the electrically non-conductive part 22.

The metal cover 23 may be flat at least in an area adjacent to the electrically non-conductive part 22.

The electrically non-conductive part 22 may be made of plastic.

The coil 15 and the ferrite 16 may be combined in one potting 17.

The wireless charger (4,13) according to claim 12, further comprising a coil cover (18) made of plastic, the potting (17) embedded in the coil cover, the coil cover configured to be joined with the electrically non-conductive part (22).

The transformer assembly 13 or wireless charger 4,13 may comprise sealing lips bordering or encompassing the cooling channels.

The metal cover may be made of aluminium and configured for shielding the vehicle from the oscillating magnetic field.

Although the invention is illustrated above, partly with reference to some preferred embodiments, it must be understood that numerous modifications and combinations of different features of the embodiments can be made. All of these modifications lie within the scope of the appended claims.

1. A power transformer assembly to transform electromagnetic power of an oscillating electromagnetic field into electric power of an electric current for charging an electric storage device or energizing an electric load, the power transformer assembly comprising:
a magnetic assembly to receive the oscillating electromagnetic field and transform the oscillating electromagnetic field into an electric alternating current; an electronic assembly to receive the electric alternating current and transform the electric alternating current into the electric current; and
a heat dissipation means for dissipating heat generated by the magnetic assembly and by the electronic assembly during their respective power transforming operation, wherein:
a) the heat dissipation means is arranged between the magnetic assembly and the electronic assembly and in thermal contact with the magnetic assembly and the electronic assembly;
b) the heat dissipation means comprises:
a first par in thermal contact with the magnetic assembly, and
a second part in thermal contact with the electronic assembly;
c) the first part comprises a first material and/or has a first structure adapted to dissipate heat flow from the magnetic assembly; and
d) the second part comprises a second material different from the first material and/or has a second structure different from the first structure adapted to dissipate heat flow from the electronic assembly.

2. The power transformer assembly according to claim 1, wherein the first part comprises a first material having a first thermal conductivity and the second part comprises a second material having a second thermal conductivity, the second thermal conductivity being greater than the first thermal conductivity.

3. The power transformer assembly according to claim 1, wherein a thermal conductivity of the second material is greater than 100 W/(m·K).

4. The power transformer assembly according to claim 2, wherein the first material and/or the second material is a metal, a metal alloy, a polymer, a polymer blend, or a composite material.

5. The power transformer assembly according to claim 2, wherein the first material is a polymer or a polymer blend.

6. The power transformer assembly according to claim 2, wherein the second material is a metal, a metal alloy, or a composite material.

7. The power transformer assembly according to claim 1, wherein the first part comprises a portion defining ducts for a heat transfer fluid.

8. The power transformer assembly according to claim 7, wherein the first part with the duct-defining portion is made by forming a material in a mold.

9. The power transformer assembly according to claim 8, wherein the first part with the duct-defining portion is made by molding a moldable material in the mold.

10. The power transformer assembly according to claim 8, wherein the first part with the duct-defining portion is made by sintering a sinterable material within the mold.

11. The power transformer assembly according to claim 8, wherein the first part with the duct-defining portion is made by cross-linking a cross-linkable material within the mold.

12. The power transformer assembly according to claim 7, wherein the first part with the duct-defining portion is made additively in a layer-by-layer fashion.

13. The power transformer assembly according to claim 7, wherein the first part comprises a polymer.

14. The power transformer assembly according to claim 13, wherein the first part comprises a polymer matrix having particles dispersed therein, the particles being selected from the group comprising metal particles and graphite particles.

15. The power transformer assembly according to claim 1, wherein the second part comprises a solid metal material.

16. The power transformer assembly according to claim 1, wherein the second part comprises a porous metal material.

17. The power transformer assembly according to claim 1, wherein the second part comprises a metal layer.

18. The power transformer assembly according to claim 1, wherein the magnetic assembly comprises a coil.

19. The power transformer assembly according to claim 18, wherein the magnetic assembly comprises a material adjacent to the coil, the material having a permeability greater than or equal to 1.

20. The power transformer assembly according to claim 19, wherein the material adjacent the coil is a ferrite.

21. The power transformer assembly according to claim 1, wherein the electronic assembly comprises a power electronics part.

22. The power transformer assembly according to claim 1, wherein the heat dissipation means comprises a third part arranged between the first part and the magnetic assembly.

23. The power transformer assembly according to claim 22, wherein the third part comprises a solid metal material.

24. The power transformer assembly according to claim 22, wherein the third part comprises a porous metal material.

25. The power transformer assembly according to claim 22, wherein the third part comprises a metal layer.

26. The power transformer assembly according to claim 22, wherein a three-part sandwich arrangement composed of the first part, second part and the third part is arranged between the magnetic assembly and the electronic assembly and in thermal contact with each of them.

27. The power transformer assembly according to claim 7, wherein the ducts for the heat transfer fluid defined by the material of the first part comprise a plurality of flow obstacles extending across the ducts.

28. The power transformer assembly according to claim 27, wherein at least some of the flow obstacles are formed integrally with the first part.

29. The power transformer assembly according to claim 27, wherein at least some of the flow obstacles are formed integrally with the second part.

30. The power transformer assembly according to claim 27, wherein at least some of the flow obstacles are formed integrally or monolithically with the third part.

31. The power transformer assembly according to claim 7, wherein the first part comprises functional portions formed integrally with the duct-defining material of the first part.

32. The power transformer assembly according to claim 31, wherein the functional portions comprise at least one of a heat transfer fluid inlet, a heat transfer fluid outlet, a snorkel, and interface formations.
